(19) United States
(12) Patent Application Publication
(10) Pub. No.: US 2008/0181524 A1
(43) Pub. Date: Jul. 31, 2008

(54) Image evaluation method, apparatus, and program

(75) Inventors: Shunichiro Nonaka, Asaka-shi (JP); Yousuke Shirahata, Kawasaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/902,896

(22) Filed: Sep. 26, 2007

(30) Foreign Application Priority Data
Sep. 27, 2006 (JP) 261861/2006

(51) Int. Cl. G06K 9/40

(52) U.S. Cl. 382/254

(57) ABSTRACT

A method and apparatus capable of efficiently calculating evaluation values by reducing the processing time when performing image evaluation. When a processing target image for evaluation is specified, a CPU determines whether or not a processing result of a process performed when calculating a characteristic amount and/or evaluation value is tentatively stored in a cache. If the processing result is stored in the cache, an individual evaluation value calculation unit calculates a plurality of different types of individual evaluation values using the processing result stored in the cache. Then, an overall evaluation value calculation unit calculates an overall evaluation value based on the plurality of different types of individual evaluation values.

### BACKGROUND OF THE INVENTION

1. Field of the Invention

The present invention relates to an image evaluation apparatus and method. It also relates to a program for causing a computer to execute the image evaluation method.

2. Description of the Related Art

Recently, the wide spread use of digital cameras, along with a dramatic increase in the capacity of image recording media, has made it possible for users of digital cameras to record a large number of images on a single image recording medium. At the same time, this has caused the users troublesome efforts to select images to be processed from a huge number of images when, for example, placing a print order or the like. As such, in order to allow the users to efficiently select images, a function to make a short list of images based on certain conditions before the final decision for printing is made by the user or a function to select appropriate images for printing according to user preference is demanded.

For example, Japanese Unexamined Patent Publication No. 2000-137791 proposes a method for evaluating a plurality of images using the focus, amount of exposure, amount of image shake, size and contrast of subject, and the like, and displaying the images in the order of the ranking. Further, Japanese Unexamined Patent Publication No. 2002-010179 discloses a method for automatically selecting an appropriate image for printing using the evaluation value of any of image brightness, acceleration sensor output of the camera, and AF evaluation as the reference. According to these methods, the users may select high-ranked images in the evaluation as appropriate images for printing, so that the burden on the users may be reduced.

Here, when performing the image evaluation, however, it is necessary to read out an image to be evaluated from a recording medium or the like, to calculate individual evaluation values for the focus, amount of exposure, amount of image shake, size and contrast of subject, and to calculate an overall evaluation value using the individual evaluation values for each of the images to be evaluated. Here, the image is reduced first in order to reduce the amount of calculation, then characteristic amounts, such as the brightness and amount of image shake are calculated from the reduced image, and evaluation values of the image are calculated using the calculated characteristic amounts. The calculation of the characteristic amounts, however, requires an extended time, so that they can not be calculated efficiently when obtaining from a plurality of images.

### SUMMARY OF THE INVENTION

The present invention has been developed in view of the circumstances described above, and it is an object of the present invention to enable efficient calculation of evaluation values by reducing the processing time when performing image evaluation.

The image evaluation apparatus of the present invention is an apparatus including:

an individual evaluation value calculation means for calculating a plurality of different types of characteristic amounts included in a processing target image read out from a storage means storing the image, and calculating a plurality of different types of individual evaluation values, each corresponding to each of the plurality of different types of characteristic amounts;

a result storage means for storing a processing result of a process performed when calculating a characteristic amount and/or individual evaluation value of the plurality of different types of characteristic amounts and/or individual evaluation values; and

an overall evaluation value calculation means for calculating an overall evaluation value of the processing target image, which is a comprehensive evaluation value thereof, based on the plurality of different types of individual evaluation values calculated by the individual evaluation value calculation means,

wherein, if the processing result is stored in the result storage means, the individual evaluation value calculation means calculates the characteristic amounts and individual evaluation values using the processing result stored in the result storage means.

In the image evaluation apparatus of the present invention, the processing result may include an image obtained by image processing performed on the processing target image when a characteristic amount of the plurality of different types of characteristic amounts is calculated, and the result storage means may be a means having a cache function for storing the processing result tentatively.

Here, when calculating an image brightness evaluation value or a face evaluation value, the processing target image is reduced in order to reduce the amount of required calculation. The reduced image obtained in this manner, however, may be used commonly for calculating the image brightness evaluation value and face evaluation value. Further, when calculating a face evaluation value or a face expression evaluation value, it is necessary to detect a face region from a processing target image. But, the face region obtained in this manner may be used commonly for calculating the face evaluation value and face expression evaluation value. Accordingly, the referent of “an image obtained by performing image processing on the processing target image” as used herein means an image obtained by common image processing performed when calculating a plurality of different types of characteristic amounts and a plurality of different types of individual evaluation values.

In this case, a storage means that allows high-speed reading for data, though its capacity is small, in comparison with a low-speed storage means, such as hard disk, may be used as the result storage means. Use of such storage means may dramatically increase the reading speed for the processing result.

Further, in the image evaluation apparatus of the present invention, when a plurality of processing target images is stored in the storage means: the processing result may include an image obtained by performing image processing on each of the plurality of processing target images, and information indicating calculation statuses of the characteristic amounts and individual evaluation values of each of the plurality of processing target images; and the result storage means may be a means for storing the processing result including each of the images obtained by the image processing performed on each of the plurality of processing target images, and the information indicating the calculation statuses.

More specifically, a storage means having a large capacity, such as a hard disk or the like, may be used as the result storage means.

The image evaluation method of the present invention is a method including the steps of:

calculating a plurality of different types of characteristic amounts included in a processing target image read out from a storage means storing the image;

calculating a plurality of different types of individual evaluation values, each corresponding to each of the plurality of different types of characteristic amounts;

storing a processing result of a process performed when calculating a characteristic amount and/or evaluation value of the plurality of different types of characteristic amounts and/or individual evaluation values; and

calculating an overall evaluation value of the processing target image, which is a comprehensive evaluation value thereof, based on the plurality of different types of individual evaluation values,

wherein, if the processing result of the processing target image is stored, the characteristic amounts and individual evaluation values are calculated using the stored processing result.

Note that the image evaluation method of the present invention may be provided in the form of a program for causing a computer to execute the method.

According to the present invention, a plurality of different types of characteristic amounts included in a processing target image read out from a storage means storing the image is calculated, and a processing result of a process performed when calculating a characteristic amount and/or individual evaluation value is stored. Then, a plurality of different types of individual evaluation values, each corresponding to each of the plurality of different types of characteristic amounts, is calculated, and an overall evaluation value of the processing target image is calculated based on the obtained plurality of different types of individual evaluation values. Here, if the processing result of the processing target image is stored, the individual evaluation values are calculated using the stored processing result. Thus, if a processing result of an image specified as the processing target is stored, a process for obtaining the processing result does not need to be performed. This reduces the processing time for the calculation of evaluation values, thereby the evaluation values may be calculated efficiently.

### BRIEF DESCRIPTION OF THE DRAWINGS

FIG. 1 is a schematic block diagram of an image evaluation apparatus according to an embodiment of the present invention, illustrating the construction thereof.

FIG. 2 is a flowchart illustrating a process performed in a first embodiment.

FIG. 3 illustrates a status table.

FIG. 4 illustrates a process management table

FIG. 5 illustrates a status management table.

FIG. 6 is a flowchart illustrating a process performed in a second embodiment.

### DESCRIPTION OF THE PREFERRED EMBODIMENTS

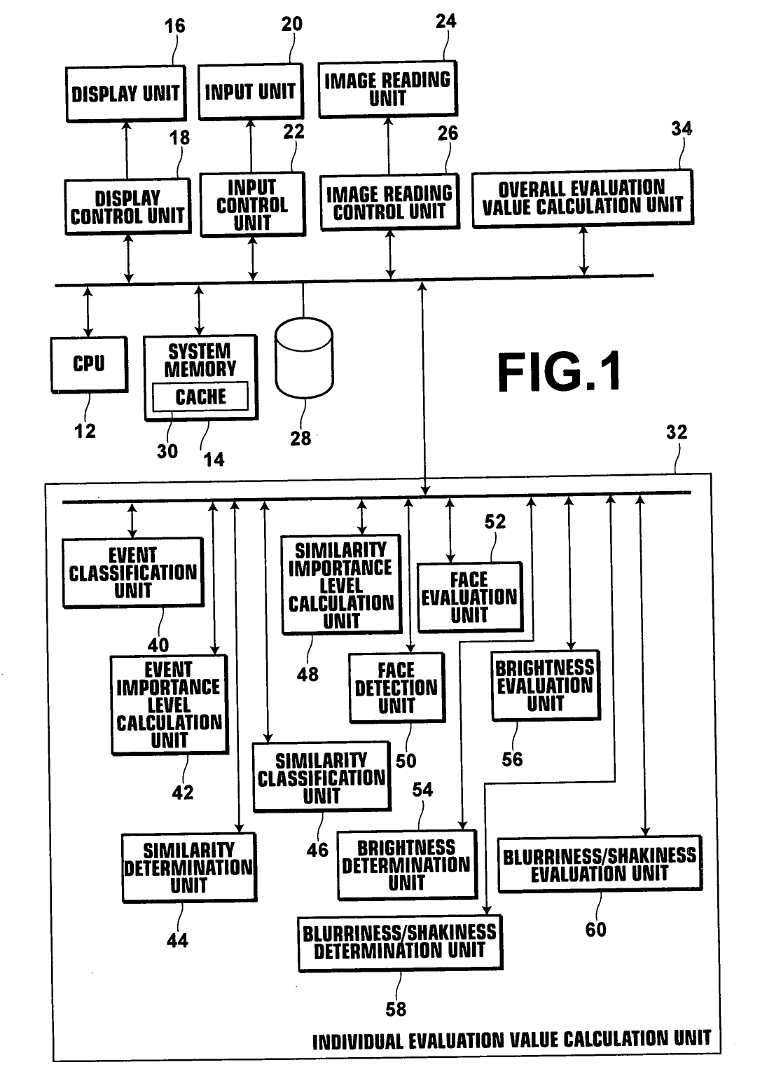

Hereinafter, exemplary embodiments of the present invention will be described with reference to the accompanying drawings. FIG. 1 is a schematic block diagram of an image evaluation apparatus according to an embodiment of the present invention, illustrating the construction thereof. As illustrated in FIG. 1, the image evaluation apparatus 1 according to a first embodiment includes: a CPU 12 that performs various control operations on image data, including record and display control operations, as well as controlling each unit of the image evaluation apparatus 1; a system memory 14 that includes a ROM having therein a program for causing the CPU 12 to operate, viewer software for viewing images, and various constants, and a RAM serving as a work area for the CPU 12 when performing the processing; a display unit 16 that includes, for example, a liquid crystal display for performing various display operations; a display control unit 18 that controls the display unit 16; an input unit 20 that includes a keyboard, mouse, touch panel, and the like for giving instructions and performing various input operations to the apparatus 1; and an input control unit 22 that controls the input unit 20. Note that a certain area of the RAM of the system memory 14 serves as a cache 30 for tentatively storing a target image for calculating an evaluation value or the like.

The image evaluation apparatus 1 further includes: an image reading unit 24 that reads out image data from a recording medium, such as a memory card having thereon image data representing an image, or the like, or records image data on a recording medium; an image reading control unit 26 that controls the image reading unit 24; and a hard disk 28 for storing various types of information, including image data.

Image data read in by the image reading unit 24 are stored in the hard disk 28. When performing a process for calculating an evaluation value to be described later, a processing target image is read out from the hard disk 28, and the process for calculating the evaluation value is performed thereon. Here, the image read out from the hard disk 28 may be stored tentatively in the cache 30 as required.

The cache 30 tentatively stores a number of images according to the memory capacity. For example, if the file size of the image is 1MB, and the memory capacity of the cache 30 is 3MB, then three images are tentatively stored in the cache 30. When a new image is read out, it is stored in the cache 30 in place of the least recent image.

The image evaluation apparatus 1 further includes: an individual evaluation value calculation unit 32 that calculates, when a processing target image and an evaluation item are specified by an operator using the input unit 20, the evaluation value of the evaluation item of the processing target image (individual evaluation value); and an overall evaluation value calculation unit 34 that calculates an overall evaluation value of the processing target image based on the individual evaluation value calculated by the individual evaluation value calculation unit 32.

The individual evaluation value calculation unit 32 includes: an event classification unit 40 that classifies a plurality of images read in by the image reading unit 24 into a plurality of groups with respect to each event, and calculates information indicating to which group each image belongs as one of the characteristic amounts of the images; an event importance level calculation unit 42 that calculates an event importance level, which is the importance level of each of the plurality of event groups classified by the event classification unit 40, as one of the individual evaluation values of each image classified into each group; a similarity determination unit 44 that calculates a similarity level between the plurality of images read in by the image reading unit 24 as one of characteristic amounts of the images; a similarity classification unit 46 that classifies the images into a plurality of similar image groups based on the similarity level calculated by the similarity determination unit 44, and calculates information indicating to which group each image belongs as one of characteristic amounts of the images; and a similarity importance level calculation unit 48 that calculates a similarity importance level, which is the importance level of each of the plurality of groups classified by the similarity classification unit 46 as one of the individual evaluation values of each image classified into each group.

The event classification unit 40 classifies a plurality of images into a plurality of groups with respect to each event, which is a set of images obtained with a bunch of intentions. More specifically, the event classification unit 40 classifies a plurality of images into a plurality of groups with respect to each event using a method in which the plurality of images is sorted by imaging date and time, and between two images where imaging time difference is greater than a predetermined value is determined to be the delimiting position between two events. Note that the method for classifying a plurality of images into a plurality of groups with respect to each event is not limited to the method described above and various methods may be used, including a method in which a single imaging location is deemed to be a single event, and images are classified into a plurality of groups with respect to each imaging location using imaging location information attached to the images.

The event importance level calculation unit 42 calculates an event importance level as one of the individual evaluation values using a method that calculates the importance level of each group based on information of the number of images included in each group, and the number of groups related to each group, as described, for example, in Japanese Unexamined Patent Publication No. 2006-171942.

The similarity importance level calculation unit 48 calculates a similarity importance level as one of the individual evaluation values using a method that further generates similar image groups within each group including similar images, and setting an importance level to each group according to the number of similar image groups and/or the number of images included in the similar image groups within each group.

The individual evaluation value calculation unit 32 further includes: a face detection unit 50 that detects a face from a processing target image, and calculates at least one of the face size, position, orientation, rotational angle of the detected face on the image, and face detection score as a characteristic amount; and a face evaluation unit 52 that calculates an evaluation value based on the characteristic amount calculated by the face detection unit 50 as one of the individual evaluation values. Note that the face detection unit 50 generates a reduced image by reducing the processing target image, detects a face from the reduced image, and calculates at least one of the face size, position, orientation, rotational angle of the detected face on the image, and face detection score is calculated as the characteristic amount of the face in order to reduce the calculation time.

The individual evaluation value calculation unit 32 further includes: a brightness determination unit 54 for calculating the brightness of a processing target image (e.g., average pixel value of all of the pixels of the image); and a brightness evaluation unit 56 for calculating an evaluation value based on the brightness of the processing target image as one of the individual evaluation values based on the brightness of the image calculated by the brightness determination unit 54. Note that the brightness determination unit 54 generates a reduced image by reducing the processing target image, and calculates the brightness of the reduced image as the characteristic amount of brightness in order to reduce the calculation time.

The individual evaluation value calculation unit 32 further includes: a blurriness/shakiness determination unit 58 that calculates information indicating the degree of blurriness and shakiness of a processing target image as one of the characteristic amounts of the image; and a blurriness/shakiness evaluation unit 60 that calculates an evaluation value based on the characteristic amount calculated by the blurriness/shakiness determination unit 58 as one of the individual evaluation values. Note that an image with a less amount of high frequency component has a greater amount of blurriness/shakiness, so that a method that calculates a value inversely proportional to the amount of high frequency component may be used for the calculation of information indicating the degree of the blurriness and shakiness. Note also that the blurriness/shakiness determination unit 58 generates a reduced image by reducing the processing target image, and calculates the information indicating the degree of blurriness and shakiness from the reduced image as the characteristic amount of blurriness/shakiness in order to reduce the calculation time.

The individual evaluation value calculation unit 32 may include a means for calculating another characteristic amount included in an image and calculating an individual evaluation value based on the calculated characteristic amount, other than the aforementioned event classification unit 40, event importance level calculation unit 42, similarity determination unit 44, similarity classification unit 46, similarity importance level calculation unit 48, face detection unit 50, face evaluation unit 52, brightness determination unit 54, brightness evaluation unit 56, blurriness/shakiness determination unit 58, and blurriness/shakiness evaluation unit 60.

Further, the individual evaluation value calculation unit 32 does not necessarily include all of the aforementioned units, namely, the event classification unit 40, event importance level calculation unit 42, similarity determination unit 44, similarity classification unit 46, similarity importance level calculation unit 48, face detection unit 50, face evaluation unit 52, brightness determination unit 54, brightness evaluation unit 56, blurriness/shakiness determination unit 58, and blurriness/shakiness evaluation unit 60. The individual evaluation value calculation unit 32 may be a unit that includes some of them, for example, the face detection unit 50, face evaluation unit 52, brightness determination unit 54, and brightness evaluation unit 56.

Still further, the individual evaluation value calculation unit 32 includes the aforementioned event classification unit 40, event importance level calculation unit 42, similarity determination unit 44, similarity classification unit 46, similarity importance level calculation unit 48, face detection unit 50, face evaluation unit 52, brightness determination unit 54, brightness evaluation unit 56, blurriness/shakiness determination unit 58, and blurriness/shakiness evaluation unit 60, so that it may calculate an event importance level, similarity image importance level, face evaluation value, brightness evaluation value, and blurriness/shakiness evaluation value as individual evaluation values for a processing target image. But an arrangement may be adopted in which individual evaluation values for only the evaluation items specified by an operator through the input unit 20 are calculated. For example, if it is indicated that image evaluation be performed based on the event importance level, face evaluation value, and brightness evaluation value by the operator as evaluation items through the input unit 20, the individual evaluation value calculation unit 32 calculates only the event importance level, face evaluation value, and brightness evaluation value.

Further, the individual evaluation value calculation unit 32 tentatively stores the reduced image of the processing target image, generated by any one of the face detection unit 50, brightness detection unit 54, and blurriness/shakiness determination unit 58 when calculating the characteristic amount, in the cache 30 as a processing result of the characteristic amount calculation, and the respective characteristic amounts are calculated by the face detection unit 50, brightness detection unit 54, and blurriness/shakiness determination unit 58. For example, if the face detection unit 50 performs the characteristic amount calculation first, the individual evaluation value calculation unit 32 stores the reduced image generated by the face detection unit 50 in the cache 30 as a processing result. In this case, the reduced image is stored in the cache 30 with the file name of the processing target image being related thereto. This eliminates the necessity for the brightness detection unit 54 and blurriness/shakiness determination unit 58 to generate the reduced image again by using the reduced image stored in the cache 30 when calculating the respective characteristic amounts. Still further, if evaluation values of a processing target image obtained in the past are available, and if the reduced image used in the past is stored in the cache 30 when calculating evaluation values again for the same processing target image, a new reduced image does not need to be generated by the face detection unit 50, brightness detection unit 54, or blurriness/shakiness determination unit 58.

Note that the cache 30 is unable to accommodate reduced images of all of the images since its capacity is limited as described above. Therefore, when a reduced image is newly generated, the new reduced image is stored in the cache in place of the least recent reduced image.

Further, an arrangement may be adopted in which the event importance level calculation unit 42, similarity importance level calculation unit 48, face evaluation unit 52, brightness evaluation unit 56, and blurriness/shakiness evaluation unit 60 calculate individual evaluation values according to intended use of the evaluation target image (e.g., selecting images for an album or present, or the like), user age group of the evaluation target image (e.g., selecting images from the viewpoints of grandparents or children), user preference of the evaluation target image, and the like. In this case, by inputting an evaluation parameter for weighting characteristic amounts according to intended use of the evaluation target image, user age group, user preference, and the like (evaluation purpose) through the input unit 20 or providing in advance, individual evaluation values may be calculated by weighting the characteristic amounts according to the evaluation purpose.

For example, in the face evaluation unit 52, an evaluation value based on the information of at least one of the face size, position, orientation, rotational angle of the detected face on the image, and face detection score detected by the face detection unit 50 is calculated as an individual evaluation value. But, these information items vary in importance according to the evaluation purpose. Accordingly, by calculating individual evaluation value after weighting these information items using an evaluation parameter for weighting characteristic amounts according to the evaluation purpose, an evaluation value according to the evaluation purpose may be calculated. For this purpose, in the present embodiment, the evaluation may sometimes be performed a plurality of times on a single image, depending on the evaluation purpose. Therefore, there may be a case in which a single image has different individual evaluation values, and hence different overall evaluation values depending on the evaluation purpose.

The overall evaluation value calculation unit 34 calculates an overall evaluation value by performing a weighted addition of the individual evaluation values calculated by the individual evaluation value calculation unit 32. The weighting factors of the individual evaluation values may be set according to the evaluation purpose as in the calculation of the individual evaluation values.

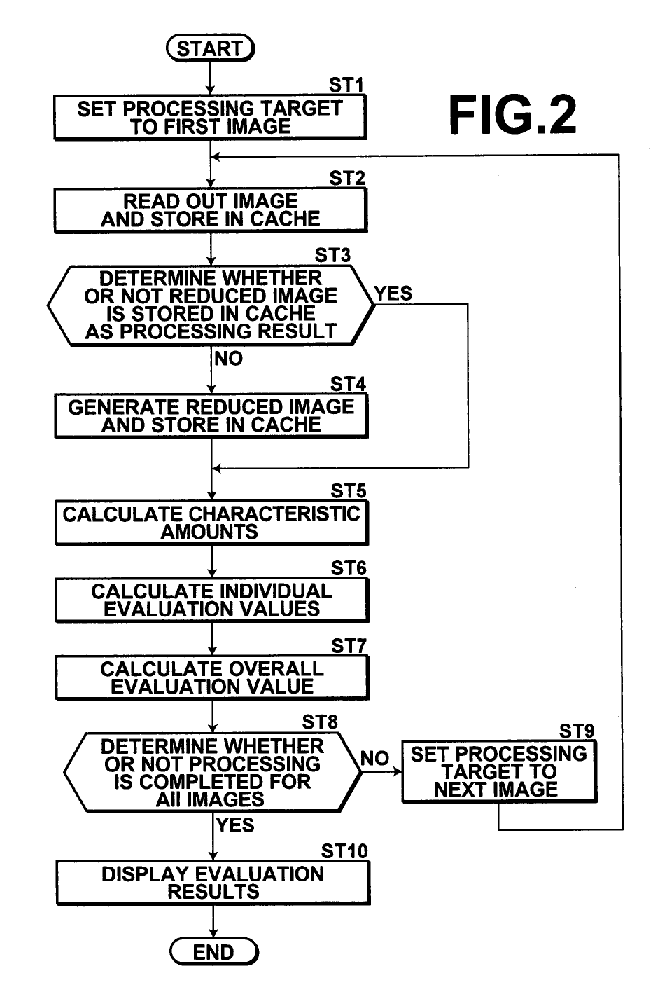

Next, a process performed in the present embodiment will be described. FIG. 2 is a flowchart illustrating the process performed in the present embodiment. In the present embodiment, it is assumed that images read in by the image reading unit 24 are stored in the hard disk 28. When a plurality of images, an evaluation item, and an evaluation purpose are specified by an operator through the input unit 20, the CPU 12 initiates the process. First, the CPU 12 sets the processing target to the first image (e.g., leading image when the images are sorted by file name) (step ST1), and the individual evaluation value calculation section 32 reads out the processing target image from the hard disk 28 and stores in the cache 30 (step ST2). Note that the image is stored in the hard disk 28 in a compressed format compressed by the JPEG method or the like. Therefore, it is decompressed before being stored in the cache 30.

The specification of the image may be performed by entering the file name, or displaying an image list on the display unit 16 and selecting the image from the list. The evaluation item or evaluation purpose may be specified by directly entering the type thereof through the input unit 20, or entering a predetermined symbol corresponding to each of the evaluation items or evaluation purposes. Alternatively, the evaluation item or evaluation purpose may be selected from a list of evaluation items or evaluation purposes displayed on the display unit 16.

Then, for the processing target image stored in the cache 30, the individual evaluation value calculation unit 32 determines whether or not a reduced image thereof generated in the past by one of the face detection section 50, brightness detection unit 54, and blurriness/shakiness determination unit 58 of the individual evaluation value calculation unit 32 is stored in the cache 30 as a processing result (step ST3).

The determination as to whether or not the reduced image of the processing target image is stored in the cache 30 may be made by determining whether or not a reduced image related to a file name corresponding to the file name of the processing target image is stored in the cache 30. In the present embodiment, it is assumed that a reduced image generated from an image processed in the past remains in the cache 30, and step ST3 is positive when the file name of the remaining reduced image corresponds to the file name of the processing target image.

If step ST3 is negative, a reduced image of the processing target image is generated and stored in the cache 30 by one of the face detection unit 50, brightness detection unit 54, and blurriness/shakiness determination unit 58 of the individual evaluation value calculation unit 32 (step ST4).

If step ST3 is positive or following step ST4, the individual evaluation value calculation unit 32 calculates characteristic amounts using the reduced image stored in the cache 30 (step ST5), and calculates individual evaluation values based on the calculated characteristic amounts (step ST6).

For example, if the individual evaluation values corresponding to the specified evaluation items are face evaluation value, image brightness evaluation value, and image blurriness/shakiness evaluation value, the face detection unit 50 calculates characteristics of the face, the brightness determination unit 54 calculates image brightness, and blurriness/shakiness detection unit 58 calculates image blurriness/shakiness degree from the reduced image as the characteristic amounts, and the face evaluation unit 52, brightness evaluation unit 56, and blurriness/shakiness evaluation unit 58 calculate the face evaluation value, brightness evaluation value, and blurriness/shakiness evaluation value respectively as the individual evaluation values.

Then, the overall evaluation value calculation unit 34 calculates an overall evaluation value of the processing target image by performing a weighted addition of the individual evaluation values (step ST7), and determines whether or not the processing for all of the images specified by the operator is completed (step ST8). If step ST8 is negative, the processing target is set to the next image (step ST9), and the process returns to step ST2 to repeat the processing from step ST2 onward. If step ST8 is positive, a list including all of the images specified by the operator together with the calculated overall evaluation values is displayed on the display unit 16 as evaluation results (step ST10), thereafter the process is terminated.

The operator may select a highly evaluated image based on the list of images and overall evaluation values displayed on the display unit 16, and print the selected image or record the image on a recording medium.

Here, an arrangement may be made in which, when displaying the list of image on the display unit 16, a predetermined number of images having high overall evaluation values are displayed in enlarged form as recommended images for printing and the like, since such images are successfully photographed images. This allows the operator to easily select images suitable for printing and the like.

As described above, if a reduced image of a processing target image is stored in the cache 30, the face characteristic amount, brightness characteristic amount, and blurriness/shakiness characteristic amount are calculated using the reduced image stored in the cache 30 in the present embodiment, so that if a reduced image of a processing target image is stored in the cache 30, a new reduced image needs not be generated. This may reduce the processing time required for calculating evaluation values, thus, the evaluation values may be calculated efficiently.

In the present embodiment, if a means for detecting a face expression as one of the characteristic amounts, and a means for calculating a face expression based evaluation value as one of the individual evaluation values are provided in the individual evaluation value calculation unit 32, these means may respectively calculate the characteristic amount and individual evaluation value using a face detected by the face detection unit 50. Accordingly, if individual evaluation values of the evaluation items specified by the operator at the start of the evaluation are face evaluation value and expression evaluation value, an image within the region of a face on an image detected by the face detection unit 50 (face region image) is stored in the cache 30 as a processing result. Then, if a face region image of a processing target image is stored in the cache 30, another face region image needs not be newly generated, so that the processing time required for calculating evaluation values may be reduced, thus, the evaluation values may be calculated efficiently.

Next, a second embodiment of the present invention will be described. The image evaluation apparatus according to the second embodiment has identical structure to that of the image evaluation apparatus according to the first embodiment, and will not elaborated upon further here. In the first embodiment, a processing result, such as the reduced image obtained when calculating a characteristic amount, is stored in the cache 30. But in the second embodiment, for all of the images stored in the hard disk 28, processing results obtained when calculating the characteristic amounts, such as reduced images thereof, and a status table, which indicates calculation statuses of the characteristic amounts and individual evaluation values, are stored in the hard disk 28.

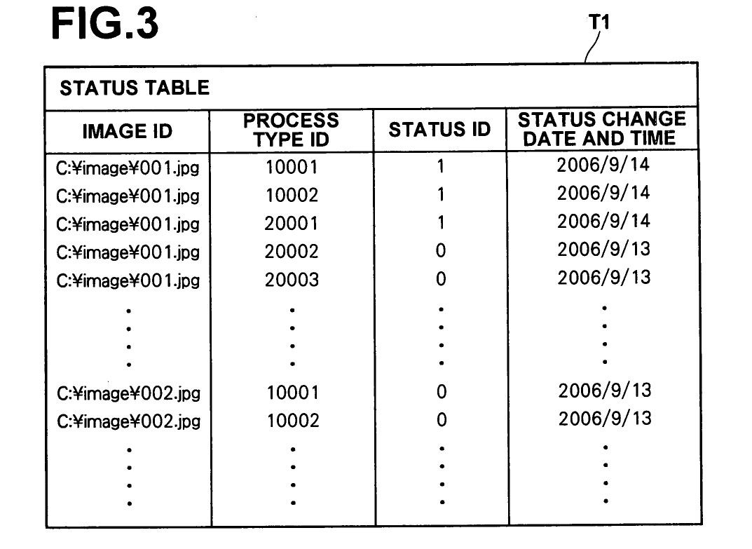

FIG. 3 illustrates a status table. As illustrated in FIG. 3, the status table T1 includes information of image ID, process type ID, status ID, and status change data and time. The image ID is an ID for identifying an image stored in the hard disk 28, and formed of file name of the image, including the path, like C:¥image¥001.jpg.

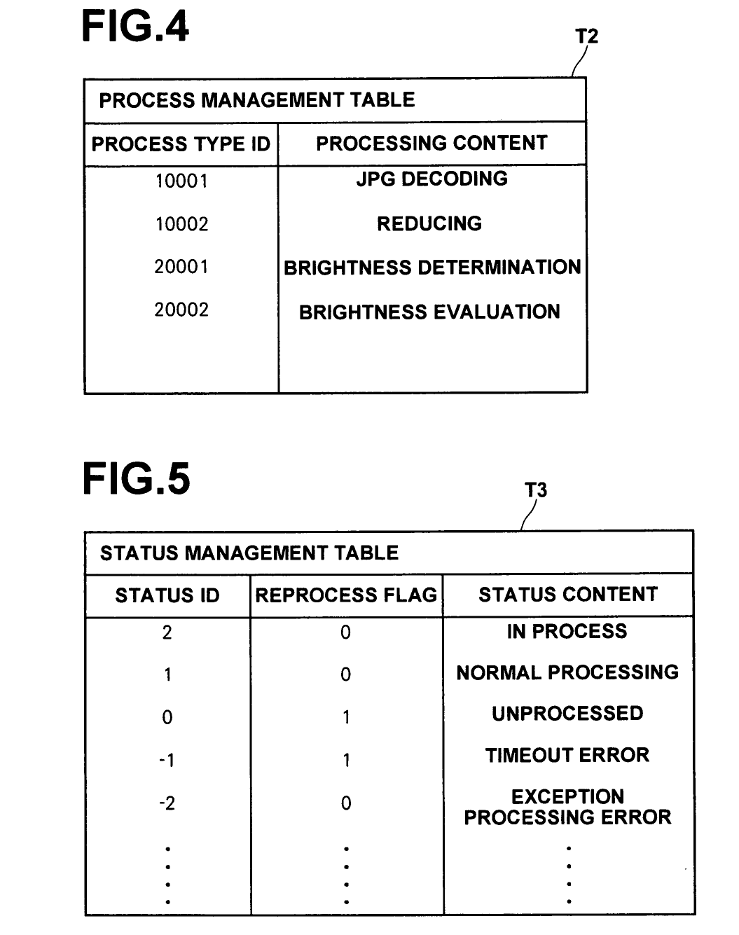

The process type ID is an ID for identifying a required process for calculating the evaluation value, and constituted by a number, such as 10001 or 10002. As illustrated in FIG. 4, the content of the process type ID is managed by a process management table T2 in which process type IDs and their processing contents are registered. In the process management table T2, for example, the process type ID=10001 is related to a JPG decoding process, which is a process for decompressing an image read out from the hard disk 28.

The status ID is an ID for indicating the processing status of a process identified by the process type ID, and constituted by a number, such as “0” or “1”. As illustrated in FIG. 5, the content of the status ID is managed by a status management table T3 in which status IDs, reprocess flags, and status contents are registered. In the status management table T3, for example, the status ID=1 is related to unprocessed status. The reprocess flag is set to “1” when the processing of the process type ID, to which the corresponding status ID is registered, is required to be performed again.

The processing result obtained by the process type ID with its status ID set to “1” (normal processing) is stored in the hard disk 28. That is, the reduced image obtained by the reducing process, image brightness characteristic amount obtained by the brightness determination process, brightness evaluation value, and the like are stored in the hard disk 28.

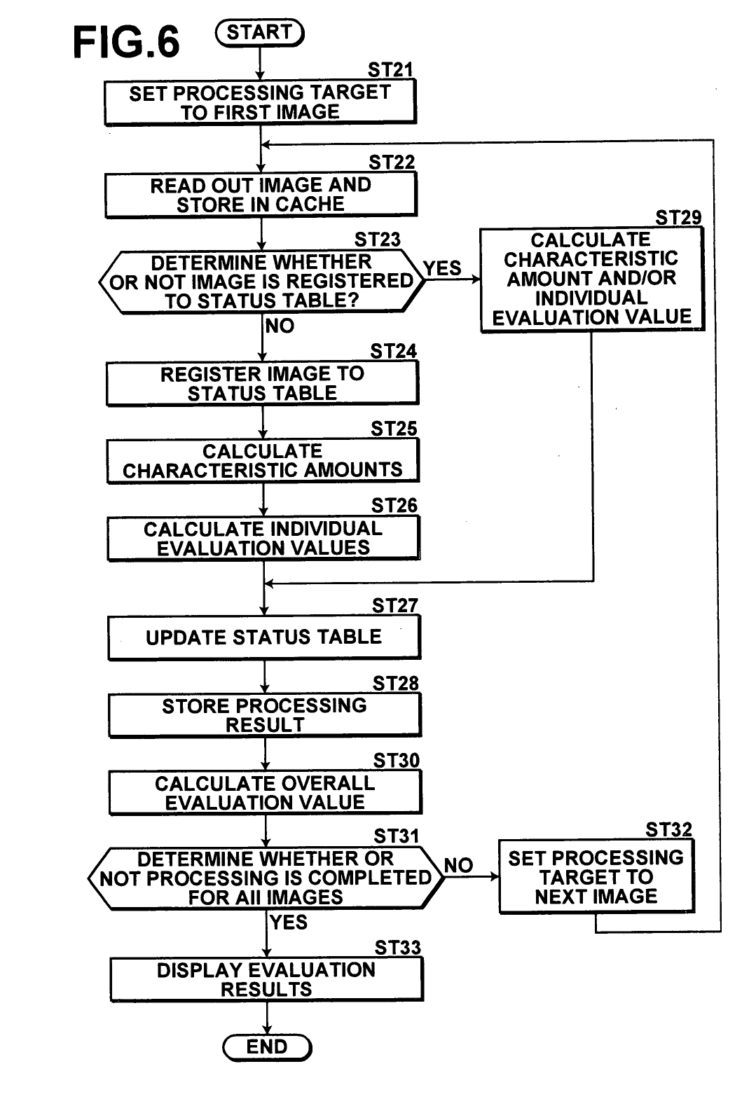

Next, a process performed in the second embodiment will be described. FIG. 6 is a flowchart illustrating the process performed in the second embodiment. In the present embodiment, it is assumed that images read in by the image reading unit 24 are stored in the hard disk 28. When a plurality of images, an evaluation item, and an evaluation purpose are specified by an operator through the input unit 20, the CPU 12 initiates the process. First, the CPU 12 sets the processing target to the first image (e.g., leading image when the images are sorted by file name) (step ST21), and the individual evaluation value calculation section 32 reads out the processing target image from the hard disk 28 and stores in the cache 30 (step ST22).

Then, the individual evaluation value calculation unit 32 determines whether or not the processing target image stored in the cache is registered to the status table T1 by referring to the table (step ST23). If step ST23 is negative, the processing target image is registered to the status table T1 (step ST24). Note that the status IDs of all of the process type IDs of the processing target image are set to “0” (unprocessed) just after its registration.

Then, the individual evaluation value calculation unit 32 calculates the characteristic amount corresponding to the evaluation value of the specified evaluation item from the image stored in the cache 30 (step ST25), and calculates the individual evaluation value based on the calculated characteristic amount (step ST26).

Further, the individual evaluation value calculation unit 32 updates the status table T1 by updating the status IDs of the processing target image (step ST27). This causes the status IDs of all of the process type IDs to be set to “1” (normal processing), and the processing results of the processes corresponding to the process type IDs with the status IDs set to “1” are stored in the hard disk 28 (step ST28) . Note that the status ID of the process, which is in process when updating, is set to “2”. When the status ID is “−1”, the reprocess flag is being set to “1”, and, therefore, the calculations of the characteristic amount and individual evaluation value are continued until they are completed successfully.

In the mean time, if step ST23 is positive, the individual evaluation value calculation unit 32 calculates the characteristic amount or individual evaluation value of the processing target image using processing results stored in the hard disk 28 by referring to the status table T1 and according to the statuses of the processing target image (step ST29). That is, for the process of the process type ID with its status being set to “1”, the processing result is stored in the hard disk. Therefore, the individual evaluation value calculation unit 32 calculates the characteristic amount and/or individual evaluation value of the processing target image using the processing result stored in the hard disk 28. More specifically, if the status ID of the reducing process is being set to “1”, the individual evaluation value calculation unit 32 calculates the characteristic amount using the reduced image stored in the hard disk 28, and if the status ID of the brightness determination process is being set to “1”, it calculates the individual evaluation value for brightness using the brightness characteristic amount stored in the hard disk 28. If the status of the process type ID is other than “1”, the individual evaluation value calculation unit 32 obtains the processing result by newly performing the process corresponding to the process type ID, and calculates the characteristic amount and/or individual evaluation value using the obtained processing result.

Thereafter, the individual evaluation value calculation unit 32 updates the status table T1 (step ST27), and stores the calculated processing results in the hard disk 28 (step ST28). Then, the overall evaluation value calculation unit 34 calculates the overall evaluation value by performing a weighted addition of the individual evaluation values (step ST30), and determines whether or not the processing for all of the images specified by the operator is completed (step ST31). If step ST31 is negative, the processing target is set to the next image (step ST32), and the process returns to step ST22 to repeat the processing from step ST22 onward. If step ST31 is positive, a list including all of the images specified by the operator is displayed on the display unit 16 together with the calculated overall evaluation values as evaluation results (step ST33), thereafter the process is terminated.

In this way, in the second embodiment, the individual evaluation value calculation unit 32 refers to the status table T1, and if a processing result of a processing target image is stored in the hard disk 28, it calculates the characteristic amount and/or individual evaluation value using the processing result stored in the hard disk 28. Therefore, if a processing result of a processing target image is stored in the hard disk 28, the process for obtaining the processing result needs not be newly performed, so that the processing time required for calculating evaluation values may be reduced, thus, the evaluation values may be calculated more efficiently.

In the first and second embodiments, if the similarity importance level is specified as the evaluation item, the processes in the similarity determination unit 44, similarity classification unit 36, and similarity importance level calculation unit 48 are performed for each of all of the images in parallel with calculations of the face evaluation values and brightness evaluation values, and the similarity importance level is calculated as the individual evaluation value of each image. Then, the overall evaluation value calculation unit 34 calculates the overall evaluation value of each image by performing a weighted addition of the similarity importance level based individual evaluation value and other individual evaluation values.

In the first and second embodiments, a certain area of the system memory 14 is used as the cache 30, but it may be provided in the CPU 12 or on the hard disk 28.

So far, the apparatus 1 according to embodiments of the present invention has been described. Programs for causing a computer to function as the means corresponding to the individual evaluation value calculation unit 32 and overall evaluation value calculation unit 34, thereby causing the computer to execute the processes like those illustrated in FIGS. 2 and 6 are also other embodiments of the present invention. Further, computer readable recording media on which such programs are recorded are still other embodiments of the present invention.

What is claimed is:

1. An image evaluation apparatus, comprising:
an individual evaluation value calculation means for calculating a plurality of different types of characteristic amounts included in a processing target image read out from a storage means storing the image, and calculating a plurality of different types of individual evaluation values, each corresponding to each of the plurality of different types of characteristic amounts;
a result storage means for storing a processing result of a process performed when calculating a characteristic amount and/or individual evaluation value of the plurality of different types of characteristic amounts and/or individual evaluation values; and
an overall evaluation value calculation means for calculating an overall evaluation value of the processing target image, which is a comprehensive evaluation value thereof, based on the plurality of different types of individual evaluation values calculated by the individual evaluation value calculation means,
wherein, if the processing result is stored in the result storage means, the individual evaluation value calculation means calculates the characteristic amounts and individual evaluation values using the processing result stored in the result storage means.

2. The image evaluation apparatus according to claim 1, wherein:
the processing result includes an image obtained by image processing performed on the processing target image when calculating a characteristic amount of the plurality of different types of characteristic amounts; and
the result storage means is a means having a cache function for storing the processing result tentatively.

3. The image evaluation apparatus according to claim 1, wherein, when a plurality of processing target images is stored in the storage means:
the processing result includes an image obtained by performing image processing on each of the plurality of processing target images, and information indicating calculation statuses of the characteristic amounts and individual evaluation values of each of the plurality of processing target images; and
the result storage means is a means for storing the processing result including each of the images obtained by the image processing performed on each of the plurality of processing target images, and the information indicating the calculation statuses.

4. An image evaluation method, comprising the steps of:
calculating a plurality of different types of characteristic amounts included in a processing target image read out from a storage means storing the image;
calculating a plurality of different types of individual evaluation values, each corresponding to each of the plurality of different types of characteristic amounts;
storing a processing result of a process performed when calculating a characteristic amount and/or evaluation value of the plurality of different types of characteristic amounts and/or individual evaluation values; and
calculating an overall evaluation value of the processing target image, which is a comprehensive evaluation value thereof, based on the plurality of different types of individual evaluation values,
wherein, if the processing result of the processing target image is stored, the characteristic amounts and individual evaluation values are calculated using the stored processing result.

5. The image evaluation method according to claim 4, wherein:
the processing result includes an image obtained by image processing performed on the processing target image when obtaining a characteristic amount of the plurality of different types of characteristic amounts; and
the storing step of the processing result stores the processing result tentatively.

6. The image evaluation method according to claim 4, wherein, when a plurality of processing target images is stored in the storage means:
the processing result includes an image obtained by image processing performed on each of the plurality of processing target images, and information indicating calculation statuses of the characteristic amounts and individual evaluation values of each of the plurality of processing target images; and
the storing step of the processing result stores the processing result including each of the images obtained by the image processing performed on each of the plurality of processing target images, and the information indicating the calculation statuses.

7. A computer readable recording medium having a program recorded thereon for causing a computer to execute an image evaluation method comprising the steps of:
calculating a plurality of different types of characteristic amounts included in a processing target image read out from a storage means storing the image;
calculating a plurality of different types of individual evaluation values, each corresponding to each of the plurality of different types of characteristic amounts;
storing a processing result of a process performed when calculating a characteristic amount and/or evaluation value of the plurality of different types of characteristic amounts and/or individual evaluation values; and
calculating an overall evaluation value of the processing target image, which is a comprehensive evaluation value thereof, based on the plurality of different types of individual evaluation values,
wherein, if the processing result of the processing target image is stored, the characteristic amounts and individual evaluation values are calculated using the stored processing result.

8. The recording medium according to claim 7, wherein:
the processing result includes an image obtained by performing image processing on the processing target image; and
the storing step of the processing result stores the processing result tentatively.

9. The recording medium according to claim 7, wherein, when a plurality of processing target images is stored in the storage means:
the processing result includes an image obtained by image processing performed on each of the plurality of processing target images, and information indicating calculation statuses of the characteristic amounts and individual evaluation values of each of the plurality of processing target images; and
the storing step of the processing result stores the processing result including each of the images obtained by the image processing performed on each of the plurality of processing target images, and the information indicating the calculation statuses.
